(19) United States
(12) Patent Application Publication
(10) Pub. No.: US 2010/0068822 A1
(43) Pub. Date: Mar. 18, 2010

(54) Device For Carrying Out Tests On And Analyzing Biological Samples With Temperature-Controlled Biological Reactions

(75) Inventors: Stefan Heydenhauss, Erfurt (DE); Jens Göhring, Jena (DE); Friedrich Menges, Jena (DE); Jürgen Bauer, Jena (DE)

Correspondence Address: RANKIN, HILL & CLARK LLP, 23755 Lorain Road - Suite 200, North Olmsted, OH, 44070-2224, US

(73) Assignee: ZENTERIS GMBH, Jena (DE)

(21) Appl. No.: 12/516,612

(22) PCT Filed: Nov. 27, 2007
(86) PCT No.: PCT/EP07/10298

§ 371 Date: May 28, 2009

(30) Foreign Application Priority Data
Nov. 28, 2006 (DE) 102006056540.1

(51) Int. Cl. G01N 21/64

(52) U.S. Cl. 436/172; 422/82.08

(57) ABSTRACT

The invention relates to a device for carrying out tests on and analyzing biological samples with temperature-controlled biological reactions. It comprises: A reaction chamber (5) for receiving a biochip (6). The reaction chamber comprises at least one transparent window (14) so that excitation light from outside can be radiated onto the biochip (6) and fluorescence light from the biochip can be radiated outward towards a measuring device. A membrane which forms at least one wall of the reaction chamber and is formed so as to be elastic so that the window and the biochip can be pressed against each other to displace the sample solution arranged thereinbetween. The device of the invention is distinguished in that the reaction chamber communicates with a compensation chamber. This permits creating predefined pressure conditions in the reaction chamber which, on the one hand, simplify the displacement of the sample solution and, on the other hand, prevent the formation of bubbles in the sample solution with high temperatures.

The present invention relates to a device for carrying out tests on and analyzing biological samples with temperature-controlled biological reactions.

As a rule, a biochip comprises a plane substrate with different scavenger molecules which are arranged at predefined points, the spots, on the surface of the substrate. A sample substance provided with a marker reacts with certain scavenger molecules according to the key-lock principle. In most cases, the scavenger molecules consist of DNA sequences (cf. EP 373 203 B1, for example) or proteins. Such biochips are also called arrays or DNA arrays, respectively. The markers are often fluorescence markers. The fluorescence intensity of the individual spots is recorded with an optical reader. Said intensity correlates with the number of the labeled sample molecules immobilized by the scavenger molecules.

WO 2005/108604 A2 describes a heatable reaction chamber for processing a biochip. Said reaction chamber comprises an elastic membrane. A silicon biochip is arranged on the membrane. A nickel chromium thin-film strip conductor is provided as the heating device. Such nickel chromium thin-film strip conductors have a high electric resistance and, accordingly, a high heating output. In addition to the strip conductors for the resistor heating, an additional strip conductor is provided for temperature measurement.

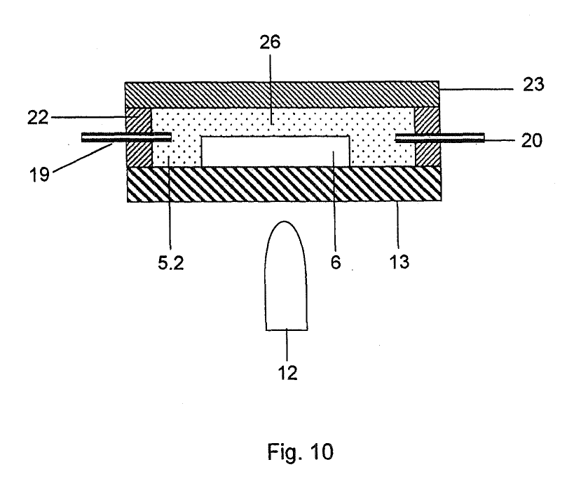

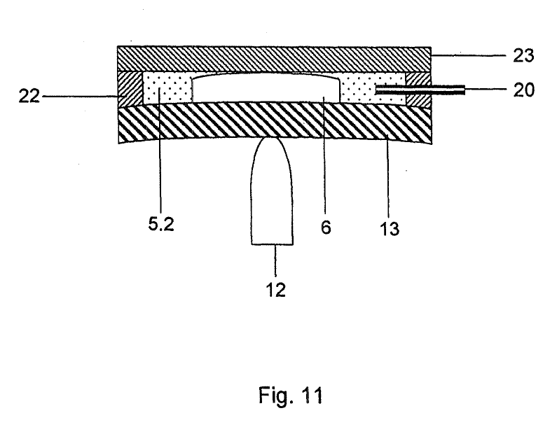

In this known reaction chamber (FIGS. 10, 11), one wall of the casing is formed as a membrane to enable the biochip 6 to be pressed against a cover glass 23 positioned opposite to the membrane 13 by means of a plunger 12. This causes a reaction liquid 26 present in the reaction chamber to be displaced from the surface of the biochip so that it does not interfere with optical detection. A seal 22 is arranged between the membrane 13 and the cover glass 23. The sample liquid 26 is supplied by means of a feed canula 19 pushed through the seal 22. During the plunging operation, excess sample liquid 26 is removed from the reaction chamber 5 by means of a pressure compensation canula 20.

WO 01/02 094 A1 describes means for supplying a specific temperature to biochips comprising micro-structured resistance heating ducts.

U.S. Pat. No. 5,759,846 and U.S. Pat. No. 6,130,056 each describe a reaction chamber for receiving biological tissues. A flexible printed circuit board with electrodes is arranged in the reaction chamber. By compressing the biological tissue and the flexible printed circuit board, an electrical contact between the biological tissue and the electrodes of the flexible printed circuit board can be established so that electrical tapping of the biological tissue can take place right away.

DE 10 2005 09 295 A1 describes a chemical reaction cartridge comprising several chambers. By passing a roll over the surface of the cartridge, liquids can be conveyed from one chamber into another chamber. Also provided is a metal rod for exerting pressure, oscillation, heat, cold or such like on the cartridge to accelerate the chemical reaction therein.

It is known from K. Shen et al., “Sensors and Actuators B 105 (2005), pages 251-258 “A Microchip-based PCR device using flexible printed circuit technology” to use a flexible printed circuit board for heating a reaction chamber intended for a PCR process. Said reaction chamber consists of a glass plate, a frame and a plastic cover. The flexible printed circuit board is arranged on the outside of the glass plate either directly by means of adhesion coupling or by means of a copper chip arranged in between. Thanks to the favorable thermal characteristics of the flexible printed circuit board, heating rates of 8° C./s were achieved. A strip conductor is formed on the flexible printed circuit board which is used both for heating and for measuring the temperature. Heating is conducted during a “heating state” while measuring may be carried out during a “sensing state” in a staggered mode.

WO 2007/051863 A2 describes a reaction chamber wherein a biochip may be processed. The reaction chamber comprises two opposite walls with the biochip arranged in between. One of the two walls has a transparent form so that it is transparent both for excitation radiation and for signals emitted by the biochip. At least one of the two walls is flexible in such a manner that the space between the biochip and the transparent wall may be compressed, resulting in displacement of the sample solution present between them.

US 2004/0047769 A1 and JP 2002-365299 A disclose a bag made of a plastic material that serves for receiving blood. Said blood may be treated for examination with a DNA array. The DNA array is integrated in the bag. The blood and a sample solution in the bag are pushed by means of rolls in the direction of the DNA array and in a disposal zone arranged behind it. The DNA array may be read in a conventional manner.

Once the blood has been introduced, all of the reactions are to proceed and be carried out in this bag without the blood and the solutions contained therein ever leaving the bag and coming in contact with the environment. This helps avoid contamination with blood that may be infected.

The present invention is based on the object of providing a device for carrying out tests on and analyzing biological samples with temperature-controlled biological reactions which comprises a hermetically sealed reaction chamber for receiving a biochip and which allows easy displacement of the sample solution from the region between the biochip and a window integrated in the reaction chamber.

This object is achieved by a device having the features of claim 1. Advantageous embodiments are indicated in the sub-claims.

The device of the invention for carrying out tests on and analyzing biological samples with temperature-controlled biological reactions comprises:
A reaction chamber for receiving a biochip, said reaction chamber comprising at least one transparent window so that excitation light from outside can be radiated onto the biochip and fluorescence light from the biochip can be radiated outward towards a measuring device.
A membrane which forms a wall of the reaction chamber so that the window and the biochip can be pressed against each other to displace the sample solution arranged thereinbetween.

This device is distinguished in that the reaction chamber communicates with a compensation chamber. When the sample solution is fed into the reaction chamber the air present therein is pushed into the compensation chamber and compressed together with the air already present there. This pressurizes the sample solution present in the reaction chamber.

This achieves the following advantages:
1. Since the sample solution is pressurized, the boiling point rises, with the result that no gas bubbles that might affect measurements evolve in the sample solution even when the temperature is increased to the range of about 100° C.
2. The effect of the air in the compensation chamber on the sample solution is similar to that of an elastic spring element permitting further displacement of the sample solution, the restoring force exerted on the sample solution by the air being small. Thus the force that has to be exerted to actuate the membrane of the reaction chamber to displace the sample solution is small in comparison with a conventional reaction chamber comprising such a membrane.
3. Providing a flexible membrane in combination with a compensation chamber permits repeated displacement of the sample solution from the reaction chamber and recycling of the sample solution into the reaction chamber which achieves intense agitation of the sample solution. For a hybridization process, this has the advantage that the individual substances in the sample solution are mixed thoroughly. For amplification, it is advantageous that an even temperature distribution in the sample solution is guaranteed by the forced convection from outside.
4. Moreover, the displacement of the sample solution from the reaction chamber is reversible if no one-way valve is provided between the reaction chamber and the compensation chamber. This permits repeated optical measurements in the reaction chamber alternating with temperature-controlled biological reactions, the majority of the sample solution having to be displaced from the reaction chamber in case of optical measurements. On the other hand, almost all of the sample solution should be present in the reaction chamber when temperature-controlled biological reactions are carried out.

The operating pressure in the reaction chamber is determined by the size of the volume of the compensation chamber. If the volume of the compensation chamber is larger than that of the reaction chamber, a pressure of less than 1 bar builds up when all of the reaction chamber is loaded with the sample solution. If the volume of the compensation chamber corresponds to the volume of the reaction chamber, a pressure of about 1 bar builds up when all of the reaction chamber is filled with the sample solution. However, if the volume of the compensation chamber is smaller than the volume of the reaction chamber, a pressure of more than 1 bar builds up when all of the reaction chamber is loaded with the sample solution. Thus, the operating pressure in the reaction chamber can be defined selectively by setting the volume of the compensation chamber accordingly.

The membrane may be formed as a flexible printed circuit board. Heating/measuring structures may be integrated in said printed circuit board. Therefore, such a flexible printed circuit board serves not only for heating and measuring purposes, but also for displacing the sample solution from the region between the biochip and the window.

The membrane may also have the form of a transparent plastic film which serves both as a window for optical measurements and for displacing the sample solution between the biochip and the film itself. In this embodiment, it is advantageous that the biochip itself need not be moved within the reaction chamber.

The device preferably comprises a feed channel which leads to the reaction chamber and wherein a check valve is arranged. This permits loading the reaction chamber by means of a pipette. It is not necessary to use a canula for piercing the seal as is the case in conventional devices of this kind.

The body defining the reaction chamber is preferably made of COC (cycloolefin copolymer). This is an inert plastic material which does not require additional passivation of surfaces to carry out temperature-controlled biological reactions (especially the PCR method) in the reaction chamber.

A check valve may be provided in the compensation channel. Preferably, this check valve may be unlocked from outside so that the sample solution can be recycled to the reaction chamber in a controlled manner. This check valve may be provided both in the embodiment with a flexible printed circuit board and/or with a transparent plastic film.

The check valve in the compensation channel is preferably designed in such a manner that it opens only above a predefined pressure. This quickly builds up a pressure within the reaction chamber which corresponds to the pressure that opens the check valve when the reaction chamber is loaded. If this opening pressure is exceeded, the valve opens and allows the medium to flow into the compensation chamber. By providing a check valve with an opening pressure, it is possible to agitate the sample solution within the reaction chamber without the sample solution entering the compensation chamber unless the opening pressure is exceeded.

An valve that may be controlled externally and is arranged in the compensation channel may be an alternative to a check valve. This valve may be opened and closed selectively to control the exchange of the medium between the reaction chamber and the compensation chamber.

In the embodiment with a transparent plastic film, it is possible to scan the biochip in the region which has just been passed by the hold-down device (doctor blade or roll) or to scan it through a hold-down device (doctor blade or plate) in transparent form.

When using a transparent plastic film as the membrane, it is useful to provide a roll for pressing the plastic film against the biochip. Instead of or in addition to the roll, the compensation chamber may also be formed with a variable volume so that the sample solution is drawn from the reaction chamber by increasing the volume of the compensation chamber. It is also possible to use a doctor blade, especially a plastic doctor blade for spreading the plastic film on the biochip instead of the roll. In another alternative embodiment, the plastic film is pressed flat against the biochip by means of a plate so that the entire sample solution between the biochip and the plastic film is sure to be displaced.

An adhesive or sticky layer may be provided on the side of the transparent plastic film facing the biochip which may be activated when it comes in contact with the sample solution. When the plastic film is pressed against the biochip it will adhere to the biochip, preventing the sample solution from entering the space between the biochip and the plastic film. Said adhesive or sticky layer is preferably provided on that region of the film which does not come in contact with the region containing the spots of the biochip. The adhesive or sticky layer is thus arranged circumferentially around the active region of the biochip.

The invention will now be illustrated by the examples shown in the Figures wherein:

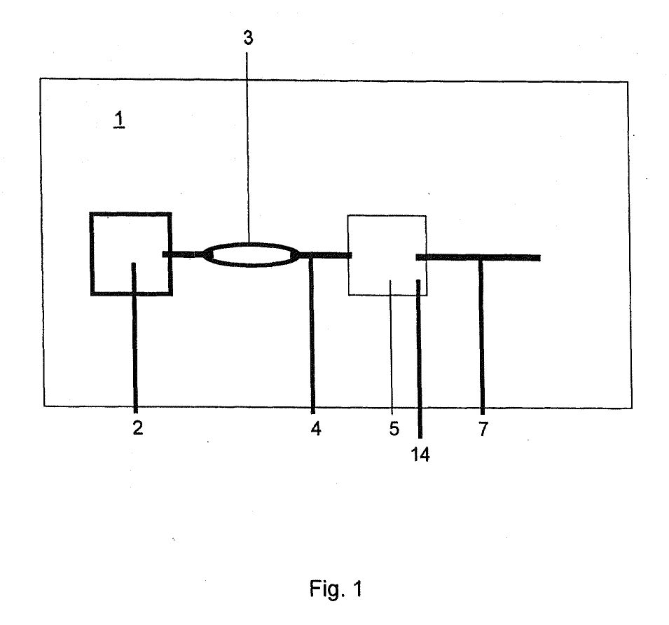

FIG. 1 shows a base body of a cartridge according to the invention in a view from below,

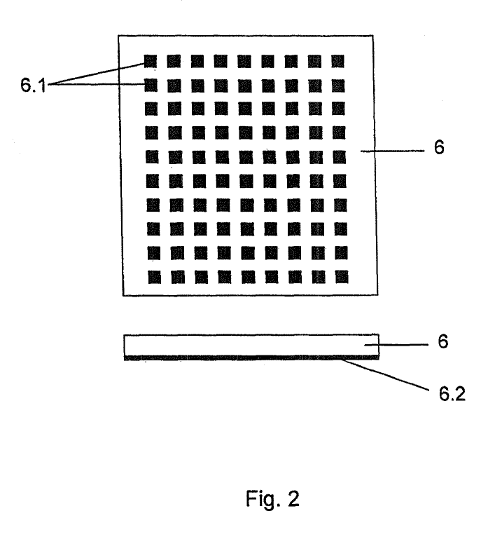

FIG. 2 an embodiment of the reaction fields (spots) on a biochip with an optically opaque and non-fluorescent rear side,

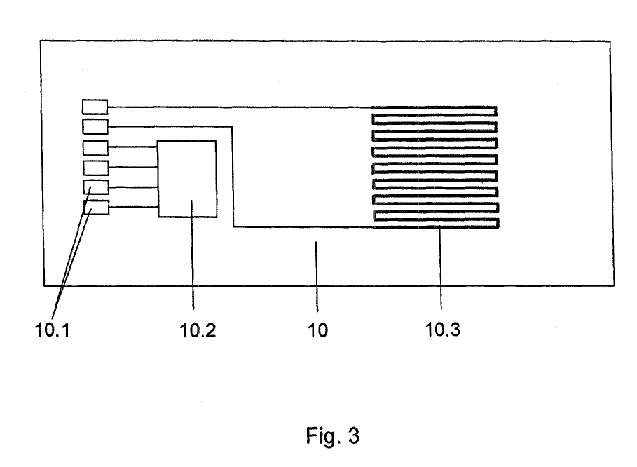

FIG. 3 an exemplary embodiment of a flexible printed circuit board which is used according to the invention, with an internal heating/measuring structure and an integrated EEPROM,

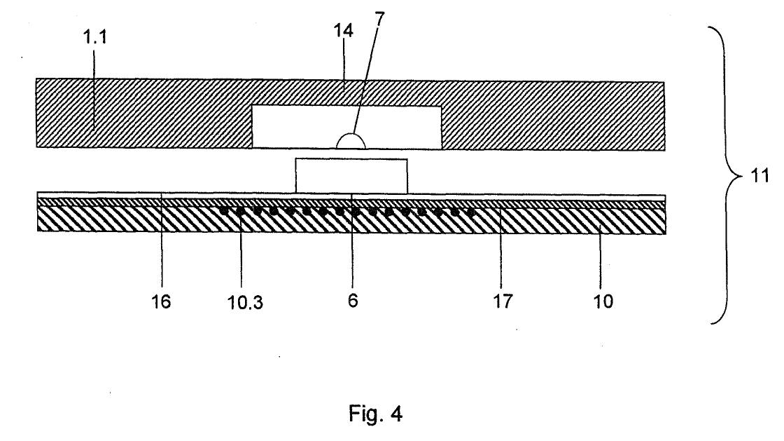

FIG. 4 a first exemplary embodiment of a biochip comprising a flexible printed circuit board and mounted to a base body,

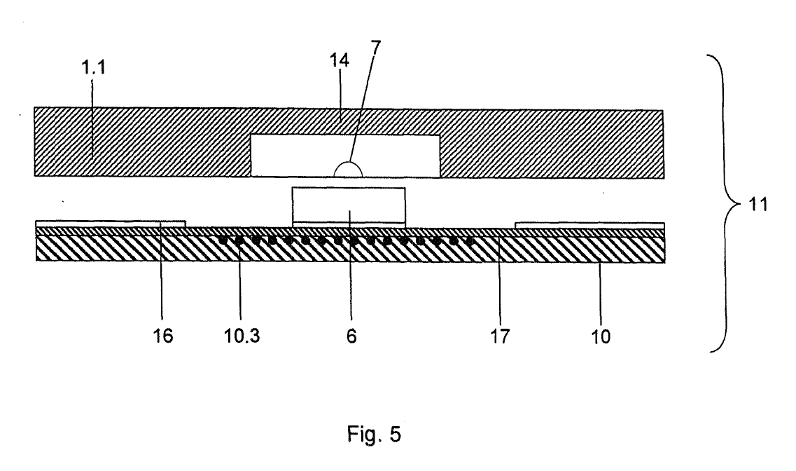

FIG. 5 a second exemplary embodiment of a biochip comprising a flexible printed circuit board and mounted to a base body,

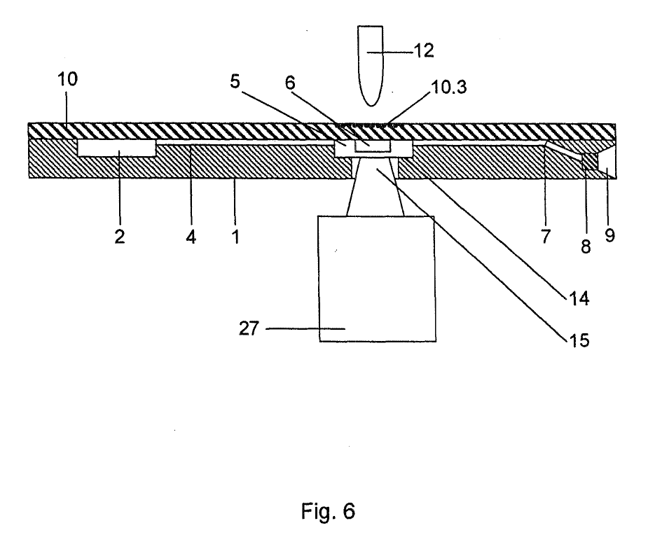

FIG. 6 an exemplary embodiment of the arrangement according to the invention of the inlay comprising the associated optical module,

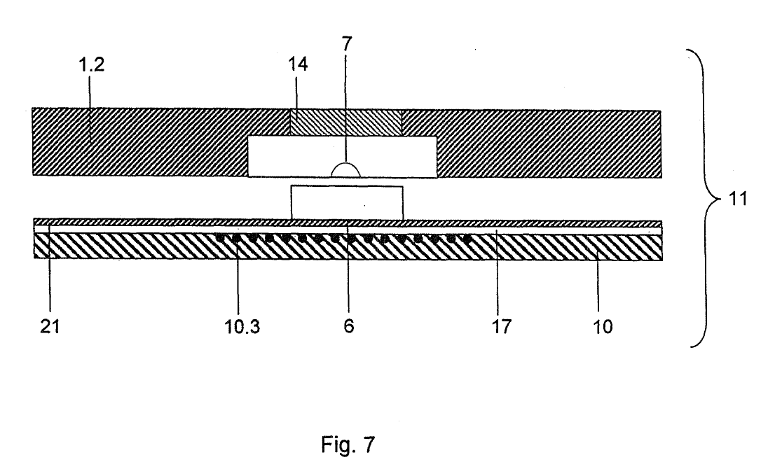

FIG. 7 an exemplary embodiment of the arrangement according to the invention, equipped with a transparent blind in a non-transparent base body,

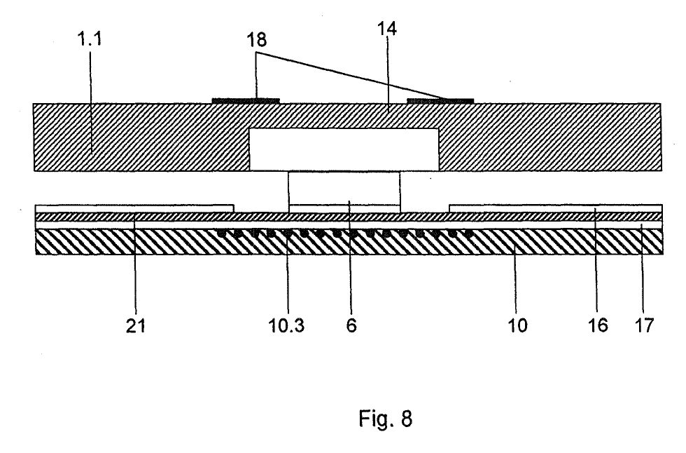

FIG. 8 an exemplary embodiment of the cartridge according to the invention, equipped with a non-transparent blind on a transparent base body,

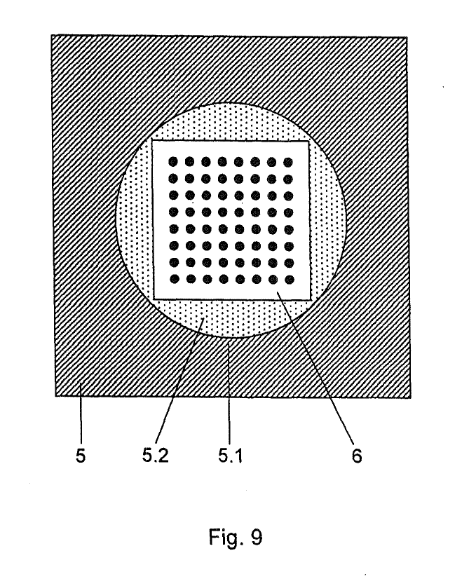

FIG. 9 the section of the illuminated area in the sample chamber of the inlay without the blind,

FIG. 10 the procedural principle of feeding a sample liquid into the reaction chamber through canules according to the prior art,

FIG. 11 the procedural principle of the displacement of the excess liquid by plunger operation according to the prior art,

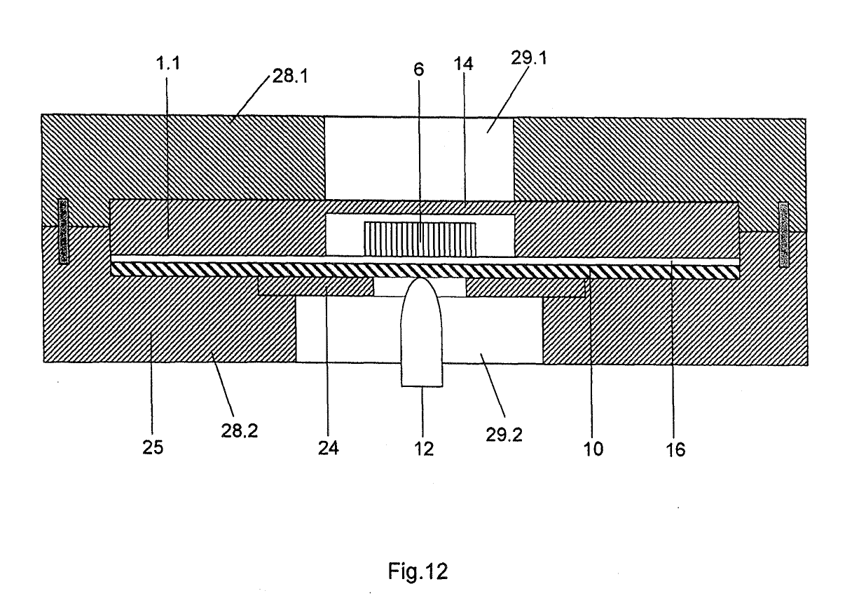

FIG. 12 a cartridge comprising an inlay and a flexible printed circuit board stabilization disc,

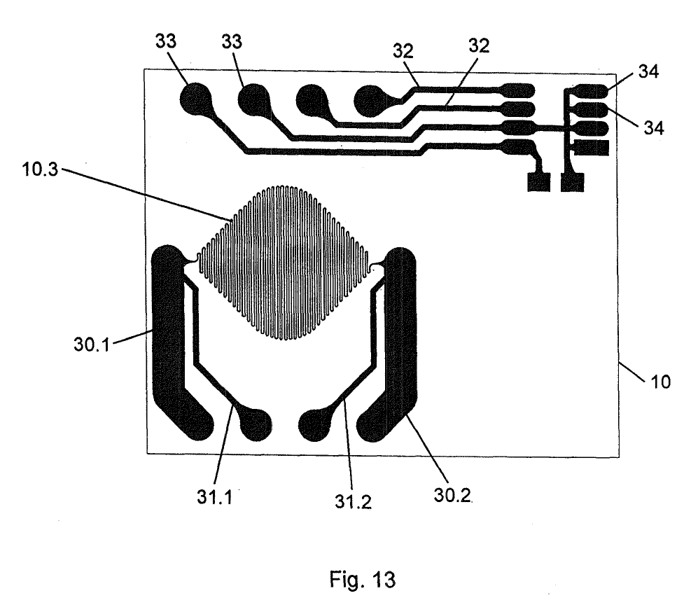

FIG. 13 a preferred exemplary embodiment of a layout of the flexible printed circuit board,

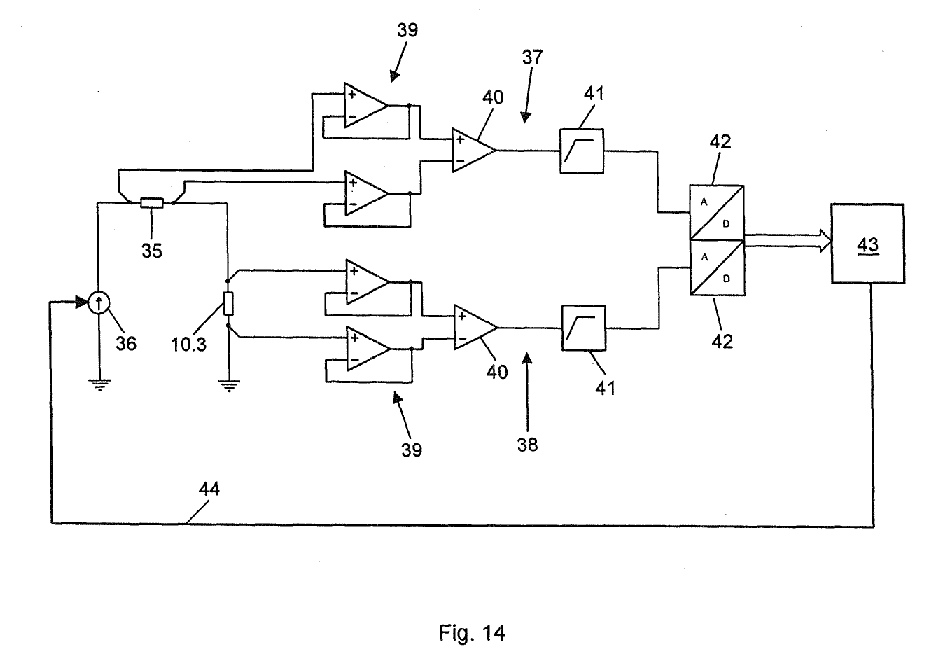

FIG. 14 a measuring/heating electronic system in a schematically simplified circuit diagram,

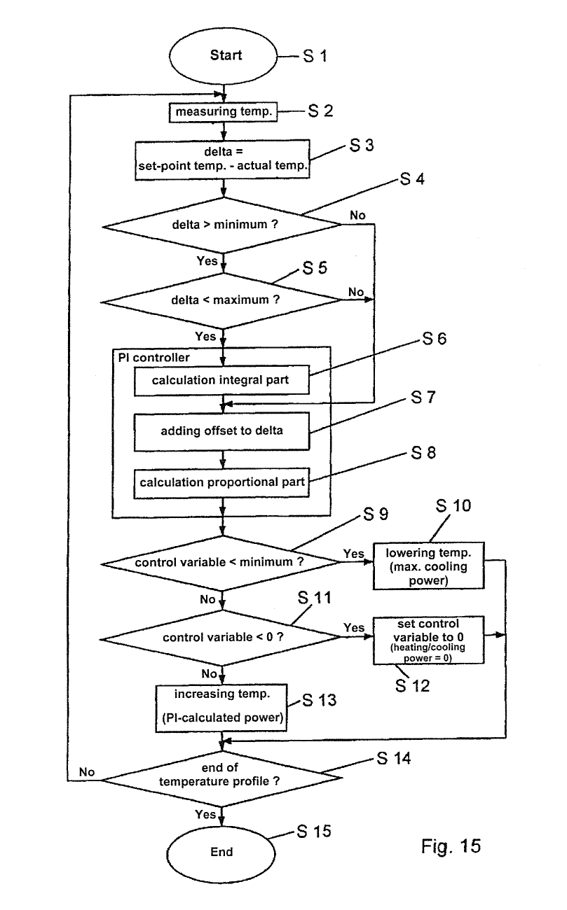

FIG. 15 a regulation method in a flowchart,

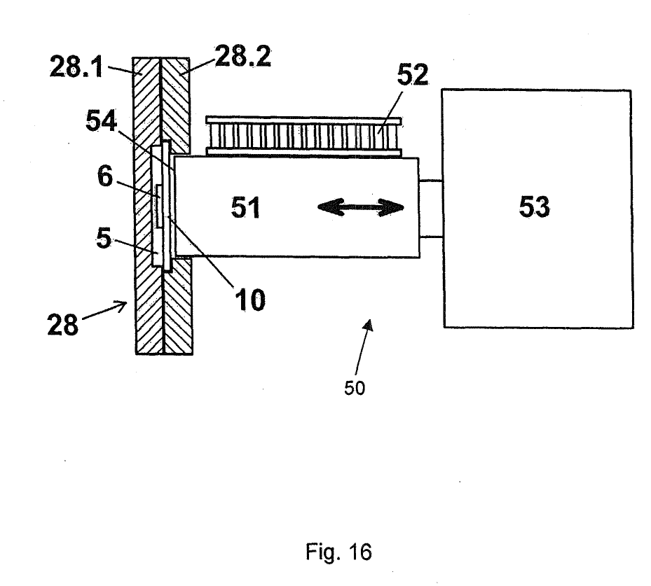

FIG. 16 a cooling device in a schematically oversimplified illustration,

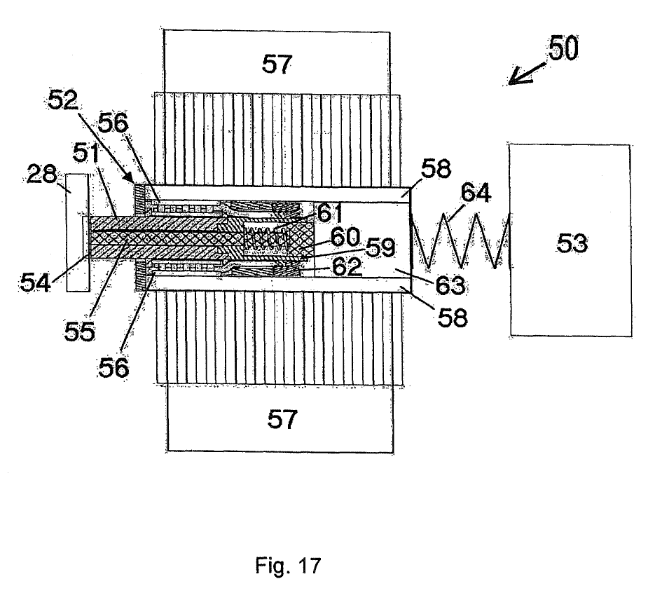

FIG. 17 a first exemplary embodiment of the cooling device in a schematically simplified sectional view,

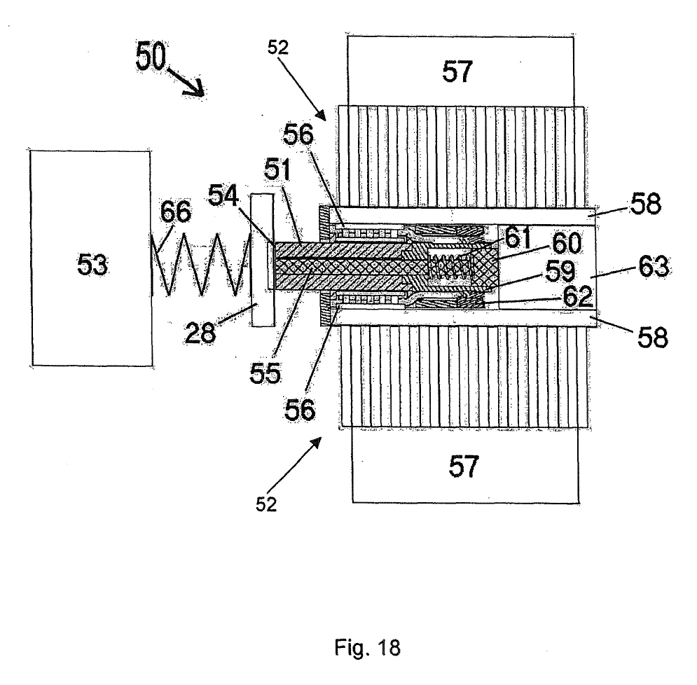

FIG. 18 a second exemplary embodiment of the cooling device in a schematically simplified sectional view,

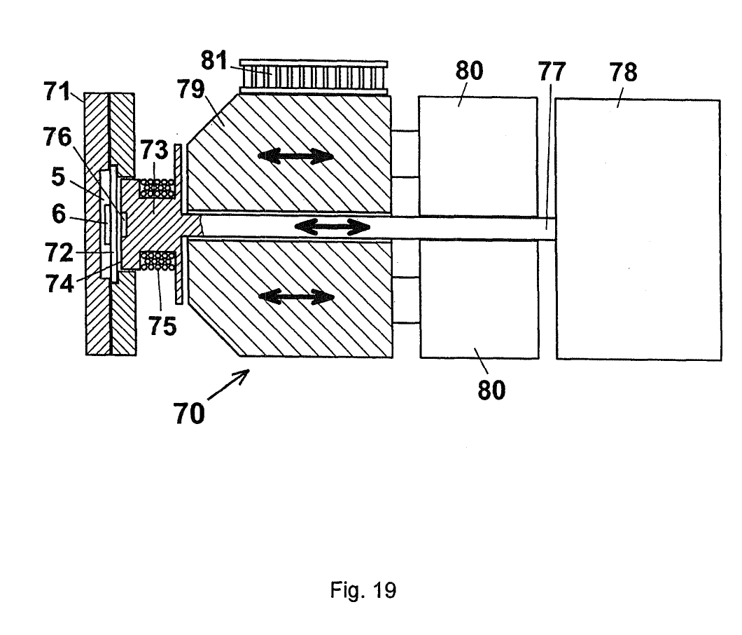

FIG. 19 an alternative heating/cooling device for heating and cooling the reaction chamber, and

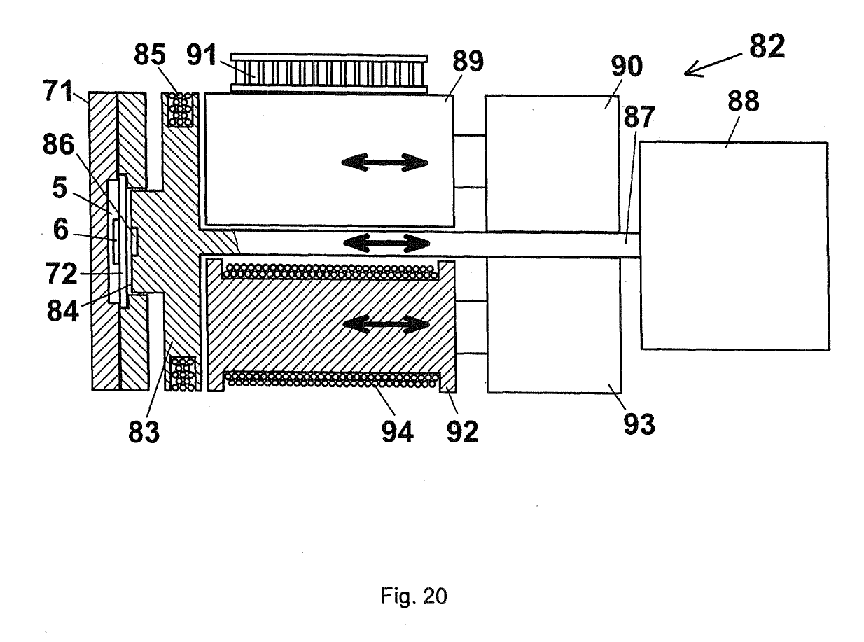

FIG. 20 a modification of the heating/cooling device of FIG. 19,

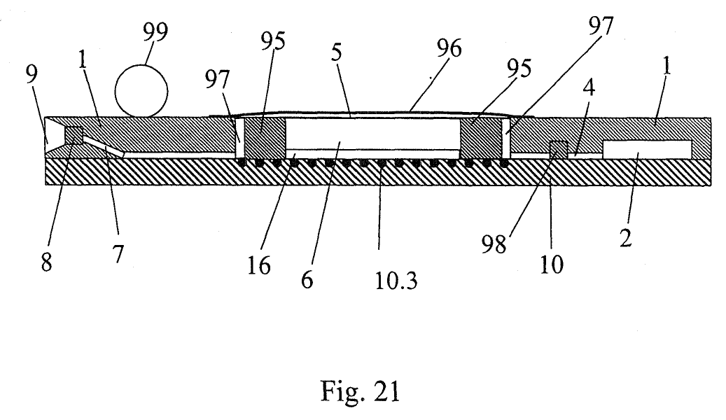

FIG. 21 a further exemplary embodiment of the device of the invention comprising a roll for pushing the sample solution into the compensation chamber in a sectional view,

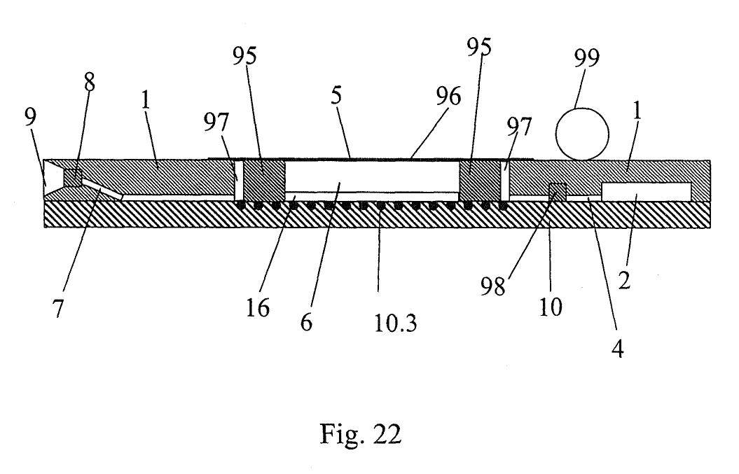

FIG. 22 the exemplary embodiment shown in FIG. 21, with excess sample solution having been pushed into the compensation chamber.

### EXEMPLARY EMBODIMENT

### Cartridge:

A cartridge comprising a biochip will be described on the basis of FIGS. 1-9 and 12.

A base body 1 which, for instance, is produced by means of injection molding, comprises on its lower side a recess for a feed channel 7 which leads from a feed opening 9 to a reaction chamber 5 (FIGS. 1, 6), and recesses for the reaction chamber 5, a compensation channel 4 between the reaction chamber 5 and a compensation chamber 2, and a recess for the compensation chamber 2. The feed opening 9 is formed with a conically tapered portion (FIG. 6), facilitating the insertion of a pipette tip. A check valve 8 is arranged in the feed opening. Provided in the compensation channel 4 is an observation window 3 through which one can see if there is any sample liquid in the compensation channel 4. At least in the region of the reaction chamber 5, the base body 1 is formed so as to be transparent and thus forms a detection window 14 through which a biochip 6 may be detected which is situated underneath.

The connection channels are as short as possible and have a cross-section which is as small as possible so that the dead volume is kept small and the required surplus of sample liquid is kept low.

At the lower side of the base body 1, there is a flexible printed circuit board 10 which in the following is referred to as flex PCB 10 (FIG. 3). The flex PCB 10 is connected with the lower side of the base body 1 such that the recesses 7, 5, 4, 3, 2 are delimited in downward direction and constitute a continuous and communicating fluid channel which is self-contained.

The flex PCB 10 comprises contact surfaces 10.1, a digital storage medium 102 (e.g. an EEPROM) and an internal heating/measuring structure 10.3 (FIG. 3).

Situated In the reaction chamber 5 is a biochip 6 (FIG. 2) comprising a number of M•N reaction fields 6.1. In order to avoid optical reflexes and undesired fluorescence radiation from the flex PCB 10, the biochip 6 is optically opaque on the rear side and non-fluorescent, e.g. is coated with black chromium 6.2. The flex PCB 10 forms a delimitation wall of the reaction chamber 5.

At first, the biochip 6 is fixed on the flex PCB 10 and, in a next step, the flex PCB 10 is connected with the base body 1. The connection between the flex PCB 10 and the biochip 6 is effected with an adhesion bonding layer 17 such as a suitable adhesive tape (suitable for biological reactions) or with a silicone glue.

Afterwards, the flex PCB 10 with the biochip 6 applied thereon is aligned relative to the base body 1, is fixed to it and forms an inlay 11. A permanent, temperature-resistant and water-proof connection may be realized, for instance, by means of a biologically compatible adhesive tape, with silicone adhesive agents, by laser welding, ultrasonic welding or other biologically compatible adhesives.

In doing so, it is possible to coat the flex PCB 10 across large areas with the adhesive tape (or adhesive agent), to bond the biochip 6 above the heating/measuring structure 10.3 of the flex PCB, and to align the base body 1 relative to the biochip 6 and to fix the flex PCB 10 over the entire area of the base body 1 (FIG. 4).

A second way of mutually connecting the flex PCB 10, the biochip 6 and the base body 1 consists in the defined areal bonding of the biochip 6 with the flex PCB 10 (adhesive agent only under the biochip) and the subsequent fixation of the base body 1 only outside the reaction chamber 5 (FIG. 5). With this kind of bonding, the heat transfer from the heating/measuring structure 10.3 in the flex PCB 10 towards the reaction chamber 5 is more efficient.

The unit of the inlay 11 pre-assembled in this way and consisting of the base plate, the biochip, the flex PCB and the check valve is pressed into a cartridge case 28 for easier handling and for stabilization (FIG. 12). The cartridge case is made up of upper and lower halves 28.1, 28.2 which delimit a parallelepiped cavity in which the inlay is received with an interlocking fit. The two halves 28.1 and 28.2 of the cartridge case each have an approximately rectangular recess 29.1 and. 29.2 in the region of the reaction chamber 5. In the recess 29.2 of the lower half 28.2 of the cartridge case, a stabilization disc 24 may be arranged which rests on the flex PCB 10 of the inlay 11 and has an opening roughly in the middle, said opening being smaller than the recess 29.2 of the lower half 28.2 of the cartridge case. Whether a stabilization disc 24 is useful depends on the pressure level within the reaction chamber 5 and on the extent of the deflection the flex PCB undergoes as a result.

### Feeding Operation:

The sample liquid is injected into the reaction chamber 5 by means of a syringe or pipette at the feed opening 9 through the check valve 8 via the feed channel 7. The sample liquid initially fills the reaction chamber 5 and then flows into the compensation channel 4 and possibly into the compensation chamber 2. The feed amount is preferably metered such that no sample liquid will enter the compensation chamber 2. During the feeding operation, an overpressure is generated in the inlay 11 and the air in the compensation chamber 2 is compressed. Through the observation window 3 in the compensation channel 4, the filling level can be monitored. As the volumes of the feed channel 7, the reaction chamber 5 and the compensation channel 4 are all known, the feeding process may take place with a constant liquid volume even without watching the optical window.

The pressure-tight sealing with the check valve 8 generates an overpressure in the reaction chamber while feeding the cartridge. The air in the compensation chamber is compressed. By varying the volumes of the reaction chamber 5 and the compensation chamber 2, the overpressure can be adjusted selectively. The overpressure is in the range from 0 bar to 1 bar. With equal volumes of the reaction chamber and of the compensation chamber, the internal pressure doubles during feeding. Temperatures of up to 100° C. may occur in the course of carrying out the temperature-controlled biological analytical reaction. The thermal expansion of the sample liquid results in its movement into the compensation channel 4. During the cooling operation, the sample liquid withdraws again. The differences in pressure at Tₘₐₓ and Tₘᵢₙ (in the cold and hot condition) are only minimal, since the air in the compensation chamber 2 will be compressed. The volume of the compensation chamber is significantly larger than the volume increase of the sample liquid during heating.

The stabilization disc 24 can minimize an expansion of the elastic flex PCB 10 during the feeding operation without losing the ability to elastically press the biochip 6 against the detection window 14 (FIG. 12).

An increase in pressure in the cartridge by 1 bar has the advantage that the boiling point of the sample liquid rises from 100° C. to approximately 125° C. As a result, the formation of air bubbles in the reaction chamber is minimized.

### Heating Device for a Temperature-Controlled Biological Analytical Reaction:

The run of a temperature-controlled biological analytical reaction requires the adjustment of precise temperatures of the sample liquid in the reaction chamber. In doing so, temperatures are adjusted to between 30° C. and 98° C. during carrying out a PCR, for instance. The temperature distribution of the sample liquid has to be homogenous in the reaction chamber and any temperature changes (heating, cooling) should occur within a short time.

Situated on the flex PCB 10 is a heating/measuring structure which acts as a heater when current is applied to the ohmic resistance. With this arrangement, the sample liquid in the reaction chamber is heated to the required temperature T. The heating/measuring structure may be simultaneously used as a temperature detector by using the resistance characteristics R(T) for determining the temperature.

The flex PCB 10 comprising the integrated heating strip conductor causes local temperature variations. Hot spots are situated directly above the heating/measuring structures. A temperature homogenization layer 21 (FIG. 7) on the flex PCB 10 causes a homogenization of the temperature distribution on the top of the flex PCB 10. The temperature homogenization layer 21 is a copper layer which is nickel-plated and provided with an additional gold layer. The gold layer has the advantage that it is inert to biological materials so that biological materials in the reaction chamber may immediately come in contact with this layer. Therefore, this reaction chamber may also be used for other experiments than those with biochip. Such a homogenization layer has a good thermal conductivity. A relatively thick copper layer could also be provided instead of a combined copper-nickel-gold coating.

A heating strip conductor integrated in the flex PCB has a low internal heat capacity. This allows to achieve higher heating rates of the sample liquid in the reaction chamber.

A preferred exemplary embodiment of the layout of the flex PCB 10 is shown in FIG. 13. The meander-like heating/measuring structure 10.3 is formed from a thin strip conductor having a width of 60 μm and a thickness of 16 μm. It has a length of approximately 480 mm. At room temperature, it has an electrical resistance of approximately 6 to 8 Ohm. The strip conductor is formed from copper, preferably copper with a purity of 99.99%. Copper of such high purity has a temperature coefficient which is nearly constant in the temperature region which is of relevance here. In its entirety, the heating/measuring structure 10.3 forms a rhombus having an edge length of approximately 9 mm. Prototypes of flexible printed circuit boards are already available which comprise a copper layer having a thickness of 5 μm, and comprising structures formed thereon which have a width of 30 μm. With such strip conductors, a resistance in the range from approximately 100 Ohm to 120 Ohm would be achieved.

The biochip 6 has an edge length of only 3 mm so that the rhombus formed by the heating/measuring structure 10.3 and the temperature homogenization layer 21 covers a larger area than the biochip.

The end points of the meander-like heating/measuring structure each merge into a very wide strip conductor 30.1 and 30.2 which serve for supplying the heating current and themselves only have a small resistance owing to their large width. Furthermore, additional strip conductors 31.1 and 31.2 are attached to these two strip conductors 30.1 and 30.2 in each case in the region of the connection point of the meander-like heating/measuring structure. These two additional strip conductors 31.1 and 31.2 serve for tapping the voltage drop at the heating/measuring structure. This will be explained in more detail below.

The flex PCB 10 comprises strip conductors 32 and corresponding contact sites 33, 34 for connecting an electrical semiconductor memory. This semiconductor memory serves for storing calibration data for the heating device and data of the biological experiments which are to be performed with the biochip of the cartridge. Therefore, these data are stored in such a manner that no confusion can occur.

FIG. 14 shows an equivalent circuit diagram of a circuit of a measuring and control device for heating and measuring the heating current by means of the meander-like heating/measuring structure or heating strip conductor. The heating/measuring structure 10.3 is illustrated in the equivalent circuit diagram as a resistor which is provided in series with a current measuring resistor 35 and a controllable current source 36. The voltage at the current measuring resistor 35 and at the heating/measuring structure 10.3 is tapped in each case by means of a separate measuring channel 37, 38. The two measuring channels 37, 38 are designed so as to be identical, with an impedance converter 39 consisting of two operation amplifiers, an operation amplifier 40 for amplifying the measuring signal, an-anti aliasing filter 41 and an ND converter 42 for converting the analog measuring signal to a digital measuring value. The two measuring channels 37, 38 thus have a high impedance and are designed so as to be identical.

The operation amplifier 40 of the two measuring channels 37, 38 are preferably operation amplifiers with a laser-trimmed internal resistance, the gain of which can be adjusted in a very precise manner. In the present exemplary embodiment, the operation amplifier LT 1991 from the Linear Technology company is used. The two A/D converters 42 of the two measuring channels 37, 38 are preferably realized by a synchronous two-channel A/D converter which simultaneously detects both channels. This will ensure that the measuring values are scanned in both channels in each case at the same points in time. This guarantees that the voltage tapped at the current measuring resistor and the voltage tapped at the heating element or the heating/measuring structure 10.3 are tapped at the same point in time and thus are based on the same heating or measuring current flowing through the current measuring resistor 35 and the heating/measuring structure 10.3, respectively.

As the heating or the measuring current is measured, this current may simultaneously be used for heating and measuring. With conventional measuring devices, a constant measuring current is fed in which is not measured at the sensor. Such a measuring current can not be varied and altered for heating; this is why heating and measuring is carried out separately from each other.

As heating and measuring is performed simultaneously with a heating and measuring current, a more precise regulation of the temperature is made possible.

Measuring the temperature is effected with a high scanning rate of, for instance, more than 1.000 Hz, preferably at least approximately 3.000 Hz. This allows an extremely precise adjustment of the temperature. It has been shown that a heating rate of 85° C./sec can be controlled with an accuracy of 0.1° C. at just below 3.000 Hz.

During cooling, a heating and measuring current flows in the order of approximately 50 mA, and during maintaining a temperature such current amounts to approximately 350 mA to 400 mA.

Due to designing the heating/measuring structure 10.3 as a long, thin and narrow strip conductor, a sufficiently high resistance is achieved even if copper is used as the strip conductor material; this resistance can be reliably detected with the 4-point-measurement which is explained above, even with a low heating current. The 4-point-measurement is independent of parasitic resistances. The reason for this is the following: As the heating/measuring structure 10.3 of the invention serves both as a heating element and as a measuring resistor for measuring the heating voltage, it is not possible to apply arbitrarily high “measuring currents” to this heating/measuring structure 10.3, because these measuring currents also act as heating currents and would result in a significant increase in temperature which, however, is not always desired. Thus there are boundary conditions which require a very low measuring current with certain process conditions so that the temperature of the reaction chamber will not be changed undesirably. As two identical measuring channels 37, 38 are used which simultaneously tap the measuring voltage with a very high impedance and measure it with very precise amplifiers, it is possible to reliably detect even low voltage drops at the resistors 35 and 10.3. Since the measuring channels are identical, systematic measuring errors cancel each other, because the resistance R of the heating/measuring structure 10.3 is measured, which is the quotient of the heating current and the measuring voltage or of the two measuring signals.

The heating/measuring structure 10.3 is formed on the side of the flex PCB 10 facing away from the biochip 6. On the opposite side of the flex PCB, the continuous temperature homogenization layer 21 is provided which leads to a uniform and quick heat distribution and allows a corresponding uniform and quick heating of the biochip 6. Moreover, the flex PCB only has a heat capacity of approximately 12 mJ/K, resulting in a quick heat transfer of the generated heat to the sample liquid present in the reaction chamber and to the biochip.

With conventional comparable heating devices, strip conductors were used in most cases which were made of a material with a higher specific resistance than that of copper, such as NiCr, for instance, and two separate strip conductors were provided both for heating and measuring, because it was deemed difficult to heat and to measure the temperature at the same time with one copper strip conductor. Hitherto, silicon substrates were used primarily as heating elements, because they appeared to be advantageous in terms of a quick distribution of the heat due to their high thermal conductivity. Such silicon substrates, however, have a heat capacity which lies a bit above the tenfold of the heat capacity of the flex PCB according to the invention. This makes the measuring operation very slow.

The measuring values obtained with the measuring circuit explained above are delivered to a digital control device 43 which drives the controllable current source 36 via a line 44.

The regulation method schematically shown in FIG. 15 is carried out in the control device 43.

This method for running a temperature profile begins with step S1. In step S2, the temperature value is measured, i.e. the resistance of the heating/measuring structure 10.3 is calculated from the two measuring values and is converted to a temperature value according to a table.

In step S3, the difference between the measured actual temperature and a set-point temperature is calculated. This value is referred to as delta value. The set-point temperature varies over time. The function describing this temporally variable temperature is referred to as temperature profile which is to be applied to the reaction chamber.

In step S4, it is polled if the delta value is larger than a predefined minimum. In case the answer to this question is “Yes”, the process flow moves to step S5 where it is polled if this delta value is smaller than a predefined maximum. If the result is “Yes” again, the process flow moves to a block of method steps S6, S7, S8 by which an integral part of a regulation value is calculated (step S6), an offset value is added to the delta value (step S7) and a proportional part is calculated by means of the delta values modified in such a manner (step S8). A control variable results from adding up the integral part and the proportional part. Adding the offset value has the effect that heating is performed with higher heating power.

If one of the two above queries (step S4) and (step S5) yields the result “No”, the process flow directly goes to step S7, omitting the calculation of the integral part. This means that an integral part is only calculated within a predefined region around the set-point temperature. This region around the set-point temperature is in the range of approximately ±1° C. to ±2° C. Therefore, the integral part is used only if the measured actual temperature is already relatively close to the desired set-point temperature. On the one hand, this prevents an overshoot of the actual temperature due to the very slow integral part. On the other hand, the integral part allows a very precise and quick approach to the desired set-point temperature in the last phase of regulation.

In step S9, it is checked if the control variable is smaller than a predefined minimum. If this is the case, the process flow moves to step S10 by which the temperature is lowered with maximum cooling power.

If, in step S9, the query produces the answer that the control variable is not smaller than a predefined minimum, the process flow moves to step S10 where it is checked if the control variable is smaller than zero. If this is the case, the process flow moves to step S12 where the control variable is set to zero. This means that the reaction chamber is cooled without any additional cooling power or the cooling die is removed from the reaction chamber. With this, an overshoot is prevented.

If, on the other hand, the query in step S11 has the result that the control variable is not smaller than zero, this means that the temperature has to be increased. Accordingly, an increase of the temperature corresponding to the determined control variable is performed in step S13. This means that the controllable current source 36 is supplied with a control signal which is proportional to the control variable, and the current source generates a corresponding heating current through the heating/measuring structure 10.3.

In step S14, it is checked if the end of the temperature profile has been reached. If this is the case, the process flow is terminated with step S15. Otherwise, the process flow moves to step S2 again. This regulation operation is repeated with the scanning frequency which amounts to at least 1.000 Hz, in particular at least approximately 3.000 Hz.

### Cooling Device for Temperature-Controlled Biological Analytical Reactions:

FIG. 16 shows the basic principle of the cooling device 50 according to the invention. This cooling device 50 comprises a cooling body which, in the following, will be referred to as cooling die 51. The particularity of such cooling die 51 is that it is arranged so as to be movable with respect to the cartridge 28 so that a cooling area thereof may be brought into contact with the cartridge 28 such that the reaction chamber 5 of the cartridge 28 may be cooled. It is possible to both arrange the cooling die 51 in a stationary position and to move the cartridge 28 with a linear drive, or to arrange the cartridge in a stationary position and to move the cooling die 51 by means of a linear drive.

The cooling die 51 is provided with a cooling unit 52 comprising a cooling element in the form of a Peltier element, a cooling body and a ventilator. The cooling die 51 can be cooled down to a predefined temperature with this cooling unit 52. Further, the cooling device 50 comprises a linear drive 53 by which the cooling die may be moved back and forth. The cooling die 51 comprises an end face which will be referred to as cooling surface 54 in the following and with which the cartridge may be brought into contact. The size of the cooling die 51 is dimensioned such that, for cooling, the cooling surface 54 in the region of the reaction chamber 5 may be brought into contact with the cartridge or the flex PCB 10.

The heat capacity of the cooling die 51 is very large compared to the heat capacity of the flex PCB 10 and the reaction chamber 5. In the exemplary embodiments described below, the heat capacity of the cooling die 51 amounts to approximately 8 to 9 J/K, for instance. The entire heat capacity of the reaction chamber 5, however, is merely approximately 0.5 J/K. On the one hand, this ensures a high heat transfer. On the other hand, the high heat capacity of the cooling die 51 means that its temperature will not significantly change even if the reaction chamber 5 cools down by a very high difference in temperature. This has the consequence that the cooling die 51 may be held at its working temperature with a relatively small cooling power. Owing to the large heat capacity of the cooling die, the required quick cooling process of the reaction chamber 5 is thus temporally uncoupled from the cooling unit 52 which gradually dissipates the heat from the cooling die 51 with a relatively small cooling power towards the environment.

Furthermore, the cooling die 51 may be maintained constantly at a temperature level, for instance 20° C., which is relatively low compared to the temperatures in the reaction chamber, whereby quick cooling processes are achieved, in particular while carrying out PCR reactions where repeated cooling-down processes are required, for instance from a temperature of 98° C. to a temperature of 40° C. to 60° C.

In that moment where the temperature of the reaction chamber 5 has reached the target temperature (or shortly before), the cooling die 51 is moved away from the reaction chamber 5. A certain amount of heating energy may be introduced, if necessary, to regulate the end temperature. This is typically the case if the set-point temperature is above room temperature. In case the temperature falls below the set-point temperature, heating is activated automatically. In case a temperature is to be set in the reaction chamber which is below room temperature, as is necessary for some biological tests, the cooling die is set to this temperature and permanently pressed against the reaction chamber.

In special applications where a low cooling rate is desired, heating energy may be applied simultaneously with the cooling die 51 making contact. This is useful in particular with low temperature changes of approximately 40° C. to 50° C. at most. Such a provision may also be used, however, for keeping a temperature below room temperature, with the die cooled down to a temperature below the target temperature being in permanent contact with the reaction chamber. A reduced cooling rate may also be achieved by reducing the contact force by which the cooling die is pressed against the reaction chamber.

A first exemplary embodiment of the cooling device according to the invention is shown in FIG. 17. This cooling device also comprises a cooling die 51, a cooling unit 52 and a linear drive 53.

Suitable linear drives are, for instance, step motors or servo gear motors with spindle or worm gears, linear step motors, piezo linear motors, motors with rack and pinion, lifting magnets, rotary magnets, voice coil magnets, motors with cam discs etc.

The cooling die 51 is shaped like a cylindrical tube. It is made of metal such as copper or aluminum. Movably supported in the interior of the cooling die 51 is a pin-shaped or bar-shaped plunger 55 formed of plastic or a metal such as copper or aluminum, for instance. The plunger 55 is arranged in the cooling die 51 so as to be longitudinally displaceable. The plunger is formed so as to be as thin as possible and is rounded at its end facing the reaction chamber, so that it presses against the reaction chamber in a preferably punctual manner.

The cooling die 51 is made of metal, as metal has good heat conductivity. It may also be formed from another material with good heat conducting properties, such as special ceramic materials (alumina ceramics etc.) or plastics with certain filler materials such as graphite, metal powder or minute metal beads, plastic nanotubes, Al₂O₃ ceramic powder.

The end face 54 of the cooling die 51 protruding from the cooling device 50 forms a cooling surface 54. The circumferential area of the cooling die 51 which is remote from the cooling area has two plane surfaces formed thereon to which cooling elements 56 in the form of Peltier elements are attached. These cooling elements are components of the cooling unit 52 which further comprises ventilators 57 and cooling bodies 58. Here, the ventilators 57 are integrated in a casing for receiving a portion of this cooling die 51.

At its rearward end face which is placed opposite to the cooling surface 54, the cooling die 51 comprises a sleeve 59 of a material with poor heat conductivity, such as plastic, for instance. This sleeve 59 delimits a cavity. The plunger 55 extends into this cavity with its rearward end and comprises a plug-shaped end body 60 slidingly supported in the sleeve 59. A spring 61 is under tension between this end body 60 and the wall of the sleeve 59 resting at the cooling die 51; this spring acts upon the plunger with a force in such a manner that the plunger 55 is pulled into the cooling die 51 with its free end face (part of the cooling surface 54) facing away from the end body 60.

The sleeve 59 is fixed in the case by means of a plastic ring 62. Moreover, the casing accommodates a linear drive 63 for acting upon the end body 60 and the plunger 55, respectively, with a force which pushes it out of the cooling die 51 with its free end to a certain extent. The entire unit made up of the cooling die 51, the plunger 55, the cooling unit 52 and the linear drive 63 is slide-mounted in axial direction of the cooling die 51 and coupled to the linear drive 53. This process of coupling is performed by means of a spring 64. The spring has a defined force/distance-characteristic and therefore allows—by means of a distance control at the linear drive 53—to control the contact force of the cooling die 51 against the flex PCB 10, without the force being measured or regulated with an additional force sensor. This type of setting the pressure force meets the requirements, because the tolerances with respect to the adjusted force are uncritical in wide ranges.

The cooling die 51 has thermal insulation at all free and accessible places. To this end, a customary, fine pored foamed plastic is provided, for instance. The cooling surface 54 of the cooling die 51 is faced down and polished. The cooling elements 56 are arranged in series and connected to an electronic control unit. Further, a temperature sensor for measuring the temperature of the cooling die is provided on the surface of the cooling die 51. The temperature regulation at the cooling die 51 is effected with a PI controller. Detecting the temperature is performed with a detecting rate of 2 Hz, for instance.

When the reaction chamber cools down by a temperature of about 40° C., the large heat capacity of the cooling die 51 and the plunger 55 which is kept cool along with the cooling die 51 results in a warming of this two-part cooling body by about 2° C. only. The required cooling power is relatively small and amounts to about 1-2 W. This allows the cooling device to be operated with batteries.

A second exemplary embodiment of the cooling device according to the invention is shown in FIG. 18. Identical parts of this second exemplary embodiment are labeled with the same reference numerals as in FIG. 17.

The cooling device 50 according to the second exemplary embodiment also comprises a cooling die 51 in the shape of a cylindrical tube having a cooling surface 54, a plunger 55 movably arranged therein, two cooling units 52 with one cooling element 56 each, a ventilator 57 and a cooling body 58, a linear drive 63 for actuating the plunger 55, and a spring 61 pulling the plunger with its free end into the cooling die 51.

The second exemplary embodiment of the cooling device 50 differs from the first exemplary embodiment in that the cooling die 51 is arranged stationarily and a linear drive 65 is provided for moving the cartridge 28. By means of a spring 66, this linear drive 65 is coupled to a fixture (not shown) for receiving the cartridge. The fixture is supported linearly. The cartridge can be placed in the fixture with a reproducible position. The force by which the cartridge is pressed against the cooling body 51, 55 may be set via the force/distance-characteristic of the spring 66.

The linear drives 53, 63 and 65 are designed so as to be actively retractable in order to replace the cartridge.

With this device, it is of advantage that only the cartridge 28 is moved, which is small compared to the remaining cooling device.

Active cooling is not necessary to run defined temperature profiles the lowest temperatures of which are about 10° C. to 20° C. above room temperature. To this end, it is sufficient to provide the cooling die with a cooling unit in the form of cooling ribs or the like, at which the heat energy absorbed by the cooling die is dissipated via convection and radiation. On principle, the cooling rates obtained from such devices are smaller than those obtained from an active cooling system. Such a cooling unit, however, would meet the demands of many temperature cycles used in practice. Other possible cooling units are systems which are used individually or in combination, such as a water cooling system or the generation of very cold air by means of a cyclone tube, which is blown against the cooling die.

### Combined Heating/Cooling Device:

FIGS. 19 and 20 each show a combined heating/cooling device for heating and cooling the reaction chamber 5 of the cartridge 28 or of another cartridge 71 which again comprises a reaction chamber 5 for receiving a biochip 6, but is not provided with separate heating means. The reaction chamber 5 is limited in a partial area by a thin plate 72 made of a material with good heat conductive properties which may be designed so as to be bendable. The plate 72 is exposed at its side facing away from the reaction chamber so that it can be contacted by the heating/cooling device 70.

The heating/cooling device 70 comprises a heating die 73 with a contact surface 74 pointing at the plate 72. The heating die 73 is made of metal and provided with a heating means 75 such as, for instance, with heating wires wound around the heating die 73. The heating means 75 is connected to a control device (not shown), by means of which the heating die 73 can be heated to a predefined temperature. Arranged on the contact surface 74 is a temperature sensor 76 which detects the temperature of the contact surface 74. The temperature sensor is also connected to the control device so that the control device can regulate the temperature of the heating die 73. Via an axle 77, the heating die 73 is connected with a linear drive 78 by which the heating die 73 may be moved towards the plate 72 until it contacts the latter with a predefined pressure, or may be retracted from the plate 72 of the cartridge 71 so that a predefined air gap exists between the heating die 73 and the plate 72.

The axle 77 movably supports a cooling die 79 enclosing the axle 77. The cooling die 79 is made of metal and arranged so as to be movable in the linear direction of the axle 77. The cooling die 79 is connected with an additional linear drive 80 by which the position of the cooling die 79 on the axle 77 may be adjusted. The cooling die 79 can be moved towards the heating die 73 by the linear drive 80 until the cooling die 79 contacts the heating die 73 with pressure at its side facing away from the contact surface 74. The cooling die 79 may also be removed from the heating die 73 such that an air gap is generated thereinbetween. Arranged on the cooling die 79 is a cooling unit 81 comprising a Peltier element, a cooling body and a ventilator for cooling down the cooling die to a predefined temperature.

The cooling die 79 comprises a substantially larger mass and volume than the heating die 73. Thus the cooling die 79 has a considerably larger heat capacity than the heating die 73. This circumstance has the consequence that, when the cooling die 79 contacts the heating die 73, this composed die is thermally dominated by the cooling die and acts as a die which cools the reaction chamber. The volume and the mass of the heating die 73 are small. This permits to heat up the heating die 73 to a predefined temperature with little energy.

The cooling die 79 is held at a comparably low temperature by means of the cooling unit 81.

If a predefined temperature cycle is to be run in this heating/cooling device, the heating die 73 is pressed against the plate 72 of the cartridge 71 during the heating phases. In this process, the cooling die 79 is spaced from the heating die 73. The heating die 73 is heated by means of its heating means 75 until the desired temperature is established at the boundary between the contact surface 74 and the plate 72.

During cooling phases, the heating means 75 is switched off and the cooling die 79 is pressed against the heating die 73 by the linear drive 80. The heating die 73, in turn, is in contact with the plate 72 of the cartridge 71. Due to the substantially larger heat capacity of the cooling die 79 with respect to the heat capacity of the heating die 73, the heating die 73 loses much heat energy within a short time, with the result that the heating die cools down and acts as a cooling means for the reaction chamber 5 of the cartridge 71. Even during the cooling phase, the temperature at the boundary between the heating die 73 and the plate 72 is monitored by the temperature sensor 76. If the desired temperature has been reached, both the heating die 73 and the cooling die 79 are retracted by the linear drive 78, or only the cooling die 79 is retracted and the heating die 73 is supplied with heat energy by the heating means 75, if the temperature of the reaction chamber 5 has to be maintained above room temperature. In case the temperature of the reaction chamber is to be kept below room temperature, it may also be useful that the heating die 73 continues to rest at the reaction chamber 5 and the cooling die 79 contacts the heating die 73 at the same time. Through the supply of energy from the heating means 75, the heat flow from and to the reaction chamber 5 may be controlled in such a manner that its temperature is held constant.

It is of advantage that the contact surface between the heating die 73 and the cooling die 79 is as large as possible, because a high heat flow is made possible in such case.

A second embodiment of a heating/cooling device 82 is shown in FIG. 20. This second embodiment slightly differs from the embodiment shown in FIG. 19. It also serves for contacting a cartridge 71 comprising a plate 72 by means of a heating die 83 comprising a contact surface 84. The heating die 83, in turn, is provided with a heating means 85 and a temperature sensor 86 on the contact surface 84. The heating die 83 is arranged on an axle 87 which is connected to a first linear drive 88 by which the heating die may be set into contact with the plate 72 and moved away from it. A cooling die 89 is movably arranged on the axle 87 and is in connection with a linear drive 90, so that the cooling die 89 may be set into contact with the heating die 83. Arranged on the cooling die 89 is a cooling unit 91 by which the cooling die 89 may be cooled down to a predefined temperature and maintained at this temperature. Furthermore, an additional heating die 92 is arranged on the axle 87 so as to be movable in axial direction. The additional heating die 92 is connected with a further linear drive 93, so that the additional heating die 92 may be brought into contact with the heating die 83 or removed from it. The additional heating die 92 is provided with a heating means 94 such as a coil of heating wires so as to be heated to a predefined temperature.

The volume and the mass of the cooling die 89 and of the additional heating die 92 are larger than those of the heating die 83. During a heating or cooling phase, the additional heating die 92 or the cooling die 89 is brought into contact with the heating die 83 so as to heat the heating die 83 to a predefined temperature or to cool it down to a predefined temperature within a short time. Incidentally, this combined heating/cooling device 82 works in the same manner as the heating/cooling device 70 shown in FIG. 19.

These two heating/cooling devices may provided with a plunger (not shown), extending through the axles 77 and 87, respectively, and able to act upon the plate 72 if it is designed to be flexible so as to press the biochip against an opposite detection window (not shown).

These two combined heating/cooling devices are preferably used with a cartridge 71 comprising a rigid plate 72 of a material with good thermal conductivity so as to allow quick heat transfer between the reaction chamber and the heating die. In this arrangement, the detection window opposite the plate 72 is formed so as to be elastic. While the biochip is read, the detection means (not shown) comprising a transparent plate is pressed against the detection window so that this window rests on the biochip 6. This permits to displace the sample liquid between the biochip 6 and the detection window and the individual spots of the biochip can be reliably scanned. Such a detection window may be made of a transparent, flexible plastic material.

### Image Acquisition:

When the temperature-controlled biological analytical reaction has been carried out the flex PCB is elastically deformed by pressing the plunger 55 against it if the cartridge has been used together with the flex PCB 10 so that the bonded biochip presses against the detection area (FIG. 6). In order to overcome the air pressure in the compensation chamber 2 a force F₀ has to be applied. When the area is about 0.5 cm², only approximately 5 N are required to build up a pressure of 1 bar. In addition, a defined force F₁ has to be applied in order to deform the elastic flex PCB 10 with the biochip 6 applied thereon by means of the plunger 55 in such a manner that the biochip 6 is pressed uniformly against the detection area. The sum of the forces F₀+F₁ shall not lie above 30 N.

When the plunger is working, the excess sample liquid containing colorant molecules, i.e. the supernatant, between the biochip and the detection area is pushed away. It flows through the compensation channel 4 into the compensation chamber 2. Only the colorant molecules bound on the biochip are stimulated to fluorescence by an illuminating unit of an optical module (not shown). Following the plunger operation, the illumination and detection unit of the optical module detects only the fluorescence light of the colorant molecules bound on the biochip. A suitable optical module is described in the international patent application PCT/EP2007/054823 to which reference is made herein.

Without a special blind design in the optical module, the illumination of the biochip in the reaction chamber will be circular. It is not only the rectangular biochip 6 that is illuminated, but also certain regions 5.1 of the reaction chamber beside the biochip from which a colorant-containing sample liquid 26 has not been displaced (FIG. 9). These regions show an intense fluorescence. With the optical reproduction of the biochip through the optical module on a detector, these regions indeed seem to be outside the biochip, but owing to the high colorant concentration of the sample liquid beside the biochip a part of the fluorescence light is also scattered towards the biochip and onto the reaction fields (spots). Apart from the fluorescence radiation of the spots due to the direct illumination, the detector also detects the indirect fluorescence-based scattered radiation from the regions beside the biochip. With this, the image of the spots on the biochip gets a locally inhomogenous background illumination interfering with the image illumination evaluation.

The optical fluorescence excitation of the colorant in the reaction chamber beside the biochip is prevented by means of a rectangular blind 18, 19 applied on the base body above the reaction chamber 5 or integrated therein and having geometrical dimensions which are a bit smaller than those of the biochip (FIGS. 7, 8).

This blind 18 may be introduced as an optically absorbing blind during the injection-molding process of a transparent base body 1 (FIG. 8), or as a transparent optical blind 19 or detection window 14 during the injection-molding process of a non-transparent base body (FIG. 7). It is also possible to apply the blind to the optical observation window (detection area) at a later point in time.

The Transmission of the Blind Layer Should be Smaller than 10⁻².

### Repeated Execution of the Temperature-Controlled Biological Analytical Reactions

In contrast to known devices (e.g. DE 10 2004 022 263 A1) wherein the sample liquid is irreversibly displaced from a reaction chamber by the plunger action prior to recording the image, the cartridge 28 according to the invention offers the possibility to continue the temperature-controlled biological analytical reaction when the image has been taken. If the plunger 55 is retracted, the flex PCB 10 draws back due to the overpressure in the reaction chamber 5 and the compensation chamber 2, and the sample liquid from the compensation chamber 2 flows back into the reaction chamber 5, also between the biochip 6 and the cover glass. This permits to continue the temperature-controlled biological analytical reaction even after the detection has been completed.

In principle, the cartridge according to the invention offers the possibility to perform detection of the spots on the biochip at any point in time of the biological reaction.

### Reading and Writing of Data:

Any information about the cartridge, inclusive of the biochip, has to be read by the biochip reader. For tuning exact temperatures during the run of the temperature-controlled biological analytical reaction, calibration data of the heater on the flex PCB are needed which are specific to a certain flex PCB. The information about the reaction fields (spots) applied on the biochip, ID numbers, exposure times for the image acquisition etc. also has to be read by the reader in order to control the temperature-controlled biological reaction and to permit logging and archiving.

The necessary information may be applied on the cartridge in the form of a dot-code or barcode. A dot-code reader (or bar code reader) is required for reading out these codes. Thus, storing current data is not possible.

The use of re-writable and readable manipulation-proof storage media 10.2 which advantageously are integrated on the flex PCB offers more flexibility.

Apart from the contact surfaces 10.1 of the heating/measuring structure, contacting an electrically programmable non-volatile memory may be performed on the flexible circuit board, too (FIG. 3). With this, information can be stored in digital form and retrieved at any time. The amount of data that can be stored is significantly larger than with applied bar codes or dot codes.

When a contacted, electrically programmable and non-volatile memory is employed, it is also possible to store information during the PCR or while reading the biochip. Moreover, the data can be stored so as to be protected against manipulation. When the processing has been carried out, the cartridge may also be labeled as “processed” so as to prevent renewed, unwanted processing.

A further exemplary embodiment of the device of the invention for carrying out tests on and analyzing biological samples with temperature-controlled biological reactions by means of a biochip is explained on the basis of FIGS. 21 and 22. Identical parts are designated with the same reference numerals as in the exemplary embodiments described above. They also have the same features and properties as in the exemplary embodiments described above, unless otherwise stated.

This exemplary embodiment also comprises a base body 1 which is made of plastic, in particular COC, and is arranged on a printed circuit board 10. The printed circuit board 10 may be designed so as to be rigid in this exemplary embodiment. In the base body 1, however, there are provided a recess for a feed channel 7 leading from a feed opening 9 to a reaction chamber 5 and recesses for the reaction chamber 5, a compensation channel 4 between the reaction chamber 5 and a compensation chamber 2 and a recess for a compensation chamber 2.

In the region of a heating/measuring structure 10.3 of the printed circuit board 10, the biochip 6 is fastened to the printed circuit board 10 by means of an adhesion bonding layer 16. Within the reaction chamber 5, the biochip 6 is surrounded by a frame 95, preferably in a form-locking manner, the top of which is aligned with the top of the biochip 6 and forms a plane and continuous surface with the biochip. The frame is made of plastic, in particular COC. A transparent plastic film 96 is provided as the observation window which has its edge glued to the base body 1. The film 96 entirely covers the recess for defining the reaction chamber 5 of the base body 1. Between the frame and the base body 1, a narrow gap 97 is formed into which the feed channel 7 and the compensation channel 4 open. This gap 97 is part of the reaction chamber 5 which also extends between the region of the surface of the biochip 6 and the plastic film 96.

An additional check valve 98 may be arranged in the compensation channel. This check valve 98 is preferably designed such that it opens only above a defined opening pressure. This has the effect that, while filling the reaction chamber with sample solution, no medium is directed to the compensation chamber 2 until the opening pressure is present therein. A defined opening pressure of the check valve 98 permits agitating the sample solution without the medium entering the compensation chamber as long as the pressure in the reaction chamber is not higher than the opening pressure. Agitation of the sample solution has the advantage that, on the one hand, the sample solution is thoroughly mixed and, on the other hand, uniform heat distribution is achieved within a short time.

Instead of the check valve 98, a valve which can be controlled from outside may also be arranged on the compensation channel. This valve may be an electrically controllable microfluidic valve comprising a bimetal or magnetic mechanism for opening and closing. Such valves may be integrated in the compensation channel without the need of leading any mechanical control elements towards the outside which would have to be sealed with respect to the walls of the compensation channel. A mechanically actuatable valve may also be provided which, in a very simple configuration, for instance, is designed as an elastic tube which constitutes a section of the compensation channel. Provided on the tube is a die which can be actuated by an actuator such that the tube can be compressed by the die so that the connection in the compensation channel is cut off or the tube is released by the die so that a continuous connection is present.

A valve controllable from outside has the advantage that the connection to the compensation chamber may be selectively opened and closed. If it is to be ensured that a transparent plastic film is held down on the biochip, the compensation channel is closed after a medium has been pushed into the compensation chamber. Therefore, the medium can not draw back into the reaction chamber and the film can not peel away from the biochip. After the optical measurements, the valve may be opened again so that part of the medium may return to the reaction chamber. It will then be possible to carry out temperature-controlled biological reactions once more.

On the top of the base body 1, a roll 99 is provided which rests on the base body 1 with a predefined pressure and may automatically be rolled along the surface of the base body by means of an actuation device (not shown); in the course of such process, the roll passes over the region of the reaction chamber 5.

While filling this device, the sample solution at first accumulates in the reaction chamber 5 in the region between the biochip 6 and the film 96, with air being displaced into the compensation chamber 2 and a predefined pressure building up. With the sample solution present in the reaction chamber, temperature-controlled biological reactions may be carried out in the same manner as in the exemplary embodiments explained above. After these reactions have been carried out, the roll is rolled across the reaction chamber 5, moving across the reaction chamber 5 from the side of the feed opening 9 towards the compensation chamber 2. In doing so, the sample solution present in the reaction chamber 5 is pushed towards the compensation chamber 2. The check valve 98 in the compensation channel 4 ensures that no medium flows back into the reaction chamber 5. This will guarantee that the film 96 which is pressed onto the surface of the biochip 6 by the rolling process does not peel away from the biochip 6.

As the film 96 is transparent, the optical measurements on the biochip 6 can be carried out by means of a suitable optical module. The transparent plastic film 96 is provided with an adhesive or sticky layer, preferably on the side facing the biochip 6 so that the film adheres to the biochip when it has been pressed against it. This adhesive or sticky layer may be designed such that it is not activated until it is in contact with a sample solution for a predefined period so as to avoid any unintended adherence prior to using the cartridge. The adhesive or sticky layer is preferably arranged in that region which surrounds the active region of the biochip, so that no bond connection is established between the biochip 6 and the plastic film 96 in the region of the spots of the biochip. It is preferred that mechanical spacers are arranged outside the region between the film 96 and the biochip 6 or the frame 95 wherein the film is to be pressed onto the biochip. This prevents unintentional pressing of the film against the biochip and ensures that the film is pressed against the biochip by means of a hold-down device (roll, doctor blade, plate) in a defined manner and only when the temperature-controlled biological reactions are completed.

The advantage of this arrangement over the above exemplary embodiments is that the delicate biochip 6 itself does not have to be moved; the only action is the film 96 being molded to the surface of the biochip 6.

With the exemplary embodiments explained above, the sample solution between the biochip and the detection area or the window is displaced entirely during image acquisition. In the embodiment comprising a plastic film and a hold-down device such as a roll or a doctor blade, pressing the plastic film against the biochip merely in a line-shaped manner, it is not necessary to displace the full amount of the sample solution between the plastic film and the biochip. With such an embodiment it is possible to create a line-shaped image of the biochip at the same time as moving the hold-down device on the plastic film. In this process, the biochip either is detected in the direction of movement immediately before or immediately after the hold-down device with a line camera, for instance, or is detected right through the hold-down device with a line camera if the hold-down device is designed so as to be transparent. The individual line images are composed to form a two-dimensional image. To this end, various methods are known in optical image processing (e.g. stitching). This picture taking during the movement of the hold-down device (“on the fly”) has the advantage that the sample solution is displaced only locally along a line between the plastic film and the biochip, so that the entire sample solution may remain in the reaction chamber during scanning. A compensation chamber is not necessary here.

The check valve 98 is preferably designed in such a way that it may be unlocked from outside, so that after carrying out the optical measurements, the sample solution may flow back into the reaction chamber 5 and further biological reactions may be performed.

It goes without saying that this embodiment comprising a transparent plastic film may also be provided with an observation window in the compensation channel 4 for detecting the filling level.

In a further modification of this arrangement, the volume of the compensation chamber 2 is designed for alteration from outside. This may be realized, for instance, by providing an elastic membrane as a wall of the compensation chamber 2. This wall may be moved from outside and the compensation chamber 2 may be filled by suction. This generates a suction effect by which the sample solution can be drawn off from the reaction chamber 5 and the film 96 lies flat against the surface of the biochip 6. In this embodiment, the roll 99 may be omitted.

It may also be useful to realize the film 96 so as to be somewhat thicker and stiffer in the immediate working area above the biochip 6 so as to prevent that local fluid bubbles remain between the biochip 6 and the film 96.

The invention has been explained above on the basis of exemplary embodiments in which at least one wall of the reaction chamber is made of a flexible membrane. The membrane is preferably made of an elastic material which may be elastically deformed by an appropriate actuation device (plunger, roll, doctor blade, plate).

The invention may be briefly summarized as follows:

The invention relates to a device for carrying out tests on and analyzing biological samples with temperature-controlled biological reactions. It comprises:
A reaction chamber 5 for receiving a biochip 6. The reaction chamber comprises at least one transparent window 14 so that excitation light from outside can be radiated onto the biochip 6 and fluorescence light from the biochip can be radiated outward towards a measuring device.
A membrane which forms at least one wall of the reaction chamber and is designed so as to be flexible, so that the window and the biochip can be pressed against each other to displace the sample solution arranged thereinbetween.

This device according to the invention is distinguished in that the reaction chamber communicates with a compensation chamber. This permits to create predefined pressure conditions in the reaction chamber which, on the one hand, simplify the displacement of the sample solution and, on the other hand, prevent the formation of bubbles in the sample solution with high temperatures.

### List of Reference Numerals

1 base body
1.1 transparent base body
1.2 non-transparent base body
2 compensation chamber
3 observation window
4 compensation channel
5 reaction chamber
5.1 illuminated area
6 biochip
6.1 reaction fields (spots)
6.2 rear coating
7 feed channel
8 check valve
9 feed opening
10 flexible circuit board
10.1 contact surfaces of the flexible circuit board
10.2 storage medium
10.3 heating/measuring structure of the flexible circuit board
11 inlay
12 plunger
13 membrane
14 detection window
15
16 adhesive bonding layer
17 support layer
18 blind (non-transparent)
19 feed canula
20 pressure compensation canula
21 temperature homogenization layer
22 seal
23 cover glass
24 stabilization disc
25 base body of the cartridge
26 sample liquid
27 optical module
28 cartridge
28.1 upper half of the cartridge case
28.2 lower half of the cartridge case
29.1 recess in 28.1
29.2 recess in 28.2
30.1 strip conductor (heating current)
30.2 strip conductor (heating current)
31.1 strip conductor (measuring current)
31.2 strip conductor (measuring current)
32 strip conductor
33 contact site
34 contact site
35 current measuring resistor
36 current source
37 measuring channel
38 measuring channel
39 impedance converter
40 operation amplifier
41 anti-aliasing filter
42 A/D converter
43 control device
44 line
50 cooling device
51 cooling die
52 cooling unit
53 linear drive
54 cooling area
55 plunger
56 cooling element
57 ventilator
58 cooling body
59 sleeve
60 end body
61 spring
62 plastic ring
63 linear drive
64 spring
65 linear drive
66 spring
70 heating/cooling device
71 cartridge
72 plate
73 heating die
74 contact surface
75 heating means
76 temperature sensor
77 axle
78 linear drive
79 cooling die
80 linear drive
81 cooling unit
82 heating/cooling device
83 heating die
84 contact surface
85 heating means
86 temperature sensor
87 axle
88 linear drive
89 cooling die
90 linear drive
91 cooling unit
92 additional heating die
93 linear drive
94 heating means
95 frame
96 film
97 gap
98 check valve
99 roll

1. A device for carrying out tests on and analyzing biological samples with temperature-controlled biological reactions, comprising: a reaction chamber for receiving a biochip, the reaction chamber comprising at least one transparent window so that excitation light from outside can be radiated onto the biochip and fluorescence light from the biochip can be radiated outward towards a measuring device, and at least one wall of the reaction chamber is formed as a flexible membrane in such a manner that the window and the biochip can be pressed against each other to displace a sample solution arranged therebetween, wherein, the reaction chamber communicates with a compensation chamber.

2. The device of claim 1, wherein the compensation chamber comprises only one single opening which communicates with the reaction chamber and wherein the compensation chamber is otherwise is completely sealed off from the environment.

3. The device of claim 1, wherein the reaction chamber and the compensation chamber are connected through a compensation channel which is preferably elongated and formed so as to have a small cross-section.

4. The device of claim 3, wherein an observation window is arranged in the compensation channel which is preferably enlarged a little in the region of the observation window.

5. The device of claim 1, wherein the volume of the compensation chamber is approximately equal to the volume of the reaction chamber.

6. The device of claim 1, wherein the volume of the compensation chamber is larger than the volume of the reaction chamber.

7. The device of claim 1, wherein the volume of the compensation chamber is smaller than the volume of the reaction chamber.

8. The device of claim 1, wherein the elastic membrane is a flexible printed circuit board.

9. The device of claim 1, wherein the elastic membrane is a transparent film.

10. The device of claim 9, wherein the transparent film has the form of a plate-shaped and essentially rigid observation window in the region of the biochip.

11. The device of claim 9 wherein the transparent film is provided with an adhesive or sticky layer on its side facing the biochip.

12. The device of claim 3, wherein the compensation channel has a check valve arranged in it, which allows a flow of media only towards the compensation chamber.

13. The device of claim 12, wherein the check valve may be unlocked from outside so that the sample solution can flow from the compensation chamber back into the reaction chamber.

14. The device of claim 1, wherein a valve is arranged in the compensation channel which may be controlled from outside and wherein the valve selectively blocks the flow of media between the reaction chamber and the compensation chamber.

15. The device of claim 1, wherein an actuation element selected from the group consisting of a plunger, a roll, a doctor blade, and a plate is provided in order to bias the membrane with a predefined force.

16. The device of claim 15, wherein the actuation element is formed so as to be transparent so that optical scanning through the actuation element may be performed.

17. The device of claim 1, wherein the volume of the compensation chamber may be changed from outside in such a manner that the compensation chamber, by expanding its volume, may be used for aspirating the sample solution from the reaction chamber.

18. The device of claim 1, further comprising a feed channel wherein the feed channel leads to the reaction chamber and wherein the feed channel further comprises a check valve.

19. A method for carrying out tests on and analyzing biological samples with temperature-controlled biological reactions in a reaction chamber for receiving a biochip, a wall of the reaction chamber being formed from a transparent film through which excitation light from outside can be radiated onto the biochip and fluorescence light from the biochip can be radiated outward towards a measuring device, and a line-shaped hold-down device being provided which can be moved along the film in order to press the film against the biochip, wherein, while the hold-down device presses the plastic film against the biochip in a line-shaped manner, the biochip is scanned line by line in the direction of movement immediately before or after the hold-down device or right through the hold-down device, and after several line-shaped scan operations, the line-shaped images generated in this process are composed to form a two-dimensional image.

20. The method of claim 19, wherein the hold-down device is transparent.

21. The method of claim 20, wherein the hold-down device is a roll or a doctor blade.

22. The method of claim 20, wherein the device of claim 1 is used.

23. The device of claim 11, wherein the compensation channel has a check valve arranged in it, which allows a flow of media only towards the compensation chamber.
